(19) United States
(12) Patent Application Publication
(10) Pub. No.: US 2022/0407900 A1
(43) Pub. Date: Dec. 22, 2022

(54) TARGETED TRANSCRIPTION

(71) Applicant: Avaya Management L.P., Durham, NC (US)

(72) Inventors: Harshal Ramesh Gawande, Pune (IN); Ghanshyam Asaram Baheti, Pune (IN); Ajay Jagdish Talreja, Pune (IN)

(21) Appl. No.: 17/354,929

(22) Filed: Jun. 22, 2021

(51) Int. Cl. H04L 29/06; G06F 40/10; H04L 29/08; G10L 15/16; G10L 15/22; G10L 15/18; G10L 15/06; G06F 40/166; G06N 3/08

(52) U.S. Cl. CPC H04L 65/403; G06F 40/10; H04L 67/2842; G10L 15/16; G10L 15/22; G10L 15/1815; G10L 15/063; G06F 40/166; G06N 3/08

(57) ABSTRACT

Systems and methods are provided to enable a participant who is unable to attend all or a portion of an electronic conference to receive a machine-generated summary of the portion of the electronic conference that were missed, such as due to an intermittent network issue, and/or portions of interest when a participant is unable to attend the electronic conference while it is occurring. For example, an artificial intelligence (AI) agent, such as a neural network, may determine when a subscribed subject is being discussed and generate a summary for presentation to an absent participant. Similarly, an intermittent participant may be provided with a text and/or audio summary of the content missed during a connection drop and allow the participant to quickly catch up on the conference content missed and rejoin the electronic conference.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for conference content management and particularly to providing generated portions of conference content to absent participants of a conference.

### BACKGROUND

Electronic conferences are a common means for people to conduct meetings when not able to meet face-to-face. Participants join the call, which may have a designated host or moderator, and participants may contribute to the content of the conference, such as by asking or answering questions or presenting a portion of the conference. However, often a participant is unable to maintain a connection, such as due to networking problems or other issues. Similarly, some participants are not able to attend the conference, but have an interest.

When a participant misses all or a portion of a conference, they can ask the host or other participant for notes. Some systems will record the conference and may further transcribe spoken content. While subsequent conference playback or reading of a transcript may provide the absent or transient participant with the content they missed, they are required to review the conference in a greater detail than what is necessary. For example, if a fifteen-minute discussion resulted in a particular conclusion, the absent or transient participant may need to watch a replay or read the transcript comprising superfluous information in order to get the information desired. As a result, the reply or transcript must be reviewed in greater detail and volume in order to ensure that no critical details have been missed. Reviewing a transcript can be faster, such as by doing a search on a word or phrase. However, the need to review, in time consuming detail, the recording of a conference is often still required due to transcription errors that often result from the machine-based transcription services utilized to transcribe conferences.

For transient participants, such as those having intermittent connectivity issues, a transcript is often not available. Once reconnected, they must ask the other participants to repeat anything relevant. While this may be sufficient, it is cumbersome and error prone. Participants may not recall a particular detail that was only briefly discussed or the transient participant may elect to allow the conference to continue and hope if they missed an important detail, it will be made apparent through other means. A prospect that often does not occur.

### SUMMARY

There are times that a participant is invited to an electronic conference where audio, video, documents, and/or other content is encoded for transmission over a network to communication devices associated with participants in the conference. Commonly, electronic conferences comprise an audio portion with speech received from participants. The conference, comprising conference content, continues to be created and broadcast to connected participants even while one or more participants are disconnected from the conference. For example, a conference participant may be transient, such as due to intermittent network connectivity issues, joining late, leaving early, etc. A participants may be an “absent,” participant, such as when an interested party wishes to receive the conference content, for at least a portion of the conference, but us unable to attend any portion of the conference in real-time. As a result, an absent participant, receives the conference content after the fact, such as by reviewing conference recordings, notes, transcriptions, etc., at a subsequent time. The absent participant may then provide any inputs to the conference content via other channels (e.g., email, text, etc.) after the electronic conference has concluded. As a result, some or all of a conference may be missed by one or more participants.

For intermittent participants, one solution is to record and playback the missed portion of the conference. Such a solution is often not efficient or effective due to the time required to review the content, while the conference is still progressing and new conference content being created. This can be a time-consuming task and very difficult to revisit entire missed communication along with catching up with ongoing live communication. While playback may be sped-up, comprehension may be impacted. As a result, participants may have heard, but not necessarily well enough to understand, the content missed once they rejoin the conference.

For an absent participant, portions of a conference may be of interest, such as when a particular subject is discussed. As with intermittent participants, such a reviewing process is often not efficient or effective. Reviewing a recorded conference in detail requires the presentation of a large volume of superfluous information. This may tempt the absent participant to speed-up playback or skip portions, which may cause relevant content to be missed or overlooked. Similarly, a long discussion of a relevant subject may require computational, network, and playback resources, as well as the participant's time, when only a brief summary is needed.

These and other needs are addressed by the various embodiments and configurations of the present invention. The present invention can provide a number of advantages depending on the particular configuration. These and other advantages will be apparent from the disclosure of the invention(s) contained herein.

In one embodiment, systems and methods are provided to extract pertinent details around a subject or topic of interest that is discussed in the conference, when not attending the conference. An option to subscribe to the subject or topic of interest is provided in advance of the conference, such as when responding to the meeting invite for the conference. Later, when the meeting is over, the subscriber will receive a snapshot summarizing the details around the subject or topic that has been subscribed to.

In another embodiment, systems and methods are provided to obtain a summary of details discussed while a transient participant was disconnected and presented thereto once reconnected to the conference. For example, a quick textual and/or audio summation may be provided and presented to the user, such as on a conference dashboard executing on the associated communication device.

In one embodiment, a system is disclosed for providing summarized content of an electronic conference, comprising: a network interface to a communications network; a conference server presenting conference content to a plurality of participant devices and receive the conference content from at least one of the participant devices, wherein the conference content comprises an audio portion further comprising encoded speech from speech received from at least one of the participant devices; a processor, comprising one or more microprocessors, having machine-readable instructions maintained in a non-transitory memory that, when read by the processor, cause the processor to perform: determining, at a first time, that an intermittent participant device, of the plurality of participant devices, is not receiving the conference content and, in response, initiate caching of the conference content; generating a summary of the conference content starting at the first time; and determining that the intermittent participant device is receiving the conference content, presenting the summary of the conference content to the intermittent participant device.

In another embodiment, a system is disclosed for providing summarized content of an electronic conference, comprising: a network interface to a communications network; a conference server presenting conference content to a plurality of participant devices and receive the conference content from at least one of the participant devices, wherein the conference content comprises an audio portion further comprising encoded speech from speech received from at least one of the participant devices; a processor, comprising one or more microprocessors, having machine-readable instructions maintained in a non-transitory memory that, when read by the processor, cause the processor to perform: determining, that a subscriber has registered an interest in a subject and that the conference content comprises a discussion of the subject and, in response, initiate caching of the conference content; generating a summary of the conference content; and presenting the summary to a device associated with the subscriber.

In another embodiment, a method is disclosed for providing summarized content of an electronic conference, comprising: presenting, by at least one microprocessor having a network interface to a communications network, conference content to a plurality of participant devices and receiving the conference content from at least one of the participant devices, wherein the conference content comprises an audio portion further comprising encoded speech from speech received from at least one of the participant devices; determining, at a first time, that an intermittent participant device, of the plurality of participant devices, is not receiving the conference content and, in response, initiate caching of the conference content; generating a summary of the conference content starting at the first time; and determining that the intermittent participant device is receiving the conference content, presenting the summary of the conference content to the intermittent participant device.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a first data structure in accordance with embodiments of the present disclosure;

FIG. 3 depicts a second data structure in accordance with embodiments of the present disclosure;

FIG. 4 depicts a first dialog box in accordance with embodiments of the present disclosure;

FIG. 5 depicts a second dialog box in accordance with embodiments of the present disclosure;

FIG. 6 depicts a third dialog box in accordance with embodiments of the present disclosure;

FIG. 7 depicts a fourth dialog box in accordance with embodiments of the present disclosure;

FIG. 8 depicts a fifth dialog box in accordance with embodiments of the present disclosure;

FIG. 9 depicts a first process in accordance with embodiments of the present disclosure;

FIG. 10 depicts a second process in accordance with embodiments of the present disclosure;

FIG. 11 depicts a third process in accordance with embodiments of the present disclosure; and

FIG. 12 depicts a second system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

The term “subject” generally refers to the subject of discussion during an electronic conference and may comprise more broad scope, such as one or more topics. For example, a subject may be “tickets with a high severity.” A “topic” generally refers to a granular portion of a subject, such as a ticket “D1111” within a subject. However, the embodiments herein contemplate embodiments for both subjects and topics and, therefore, subject and topic may be utilized interchangeably, unless otherwise noted or described, to disclose multiple embodiments without duplicating the description.

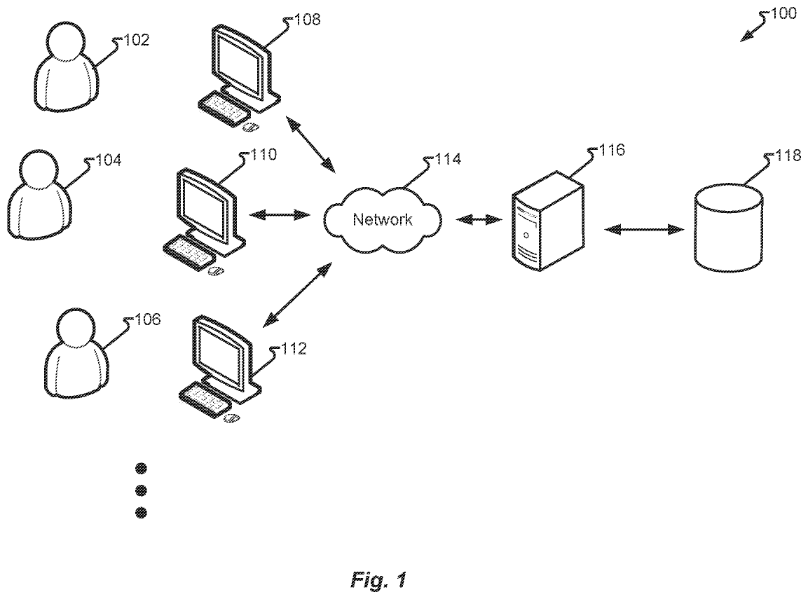

FIG. 1 depicts system 100 in accordance with embodiments of the present disclosure. System 100 illustrates one network topology for conducting an electronic conference. Server 116 broadcasts the electronic conference to each of participant communication device 108, participant communication device 110, and participant communication device 112 associated with participant 102, participant 104, and participant 106, respectively. While three participant communication devices (e.g., 108, 110, and 112) are illustrated, more communication devices and associated participants may be connected to receive the electronic conference from server 116. In other network topologies, server 116 and/or data storage 118 is incorporated into one of the participant devices (e.g., 108, 110, 112, etc.). For example, one of participant communication device 108, participant communication device 110, participant communication device 112 and or other participant communication device may provide the functionality of server 116 and/or data storage 118. Server 116 may provide other conferencing services (e.g., floor control, admitting/dropping participants, muting/unmuting participants, decoding received and/or encoding for transmission, audio and/or video content via network 114, etc.).

The electronic conference broadcast by server 116 may receive conference content in the form of encoded audio, such as speech from a participant, video, such as an image of a participant, and/or other media (e.g., screen-share images, documents, etc.) from one or more participant communication devices (e.g., 108, 110, 112, etc.) and/or a corresponding component or peripheral device associated therewith, such as a microphone, camera, etc. As a result, one speaker, such as participant 104 may speak and have their speech received and encoded for transmission on network 114 by participant communication device 110 for receipt by server 116. Server 116 in turn incorporates the received encoded speech and broadcasts the speech the conference content or a portion thereof. In other embodiments, video or other media is similarly received at server 116 from one or more of the participant devices and rebroadcast to the participants. It should be appreciated that, in certain embodiments, rebroadcasting the conference content to the source of the conference content, may be omitted, such as to avoid audio feedback or to conserve bandwidth by omitting duplicative information.

In one embodiment, one of the participants, such as participant 102 is an intermittent participant such that participant communication device 108 receives some, but not all, of the conference content broadcasts by server 116 for a particular time, such as when a network connection drops and, for the particular time, no conference content is received. In another embodiment, one of the participants, again such as participant 102 is a absent participant such that participant communication device 108 receives is not able to receive the conference content broadcasts by server 116 until after the electronic conference has concluded, such as a recorded electronic conference, transcript, summary, etc. The foregoing embodiments are described in greater detail with respect to embodiments that follow.

The systems and methods provided herein allow for an absent or intermittent participant in an electronic conference to be presented with a summary of portions of the electronic conference that were missed and/or previously identified as being relevant. This reduces the burden on systems, such as would otherwise be required to record or transcribe the entirety of an electronic conference as well as the storage of the recording and/or transcription. Additionally, presenting an entire recording or transcription requires additional network utilization (e.g., bandwidth, port, etc.) to connect and download or stream a recording and/or receive a transcription file of an entire electronic conference. Doing so results in storage, transmission, and presentation of a much larger volume of data with significant portions thereof being known to be irrelevant. By limiting the presentation of missed electronic conference to only those portions missed and/or only those portions having previously identified relevant information, to a summary of the conference content for the time missed and/or the subject(s) of interest, resources utilization may be diminished which may allow such resources to be utilized for other tasks. Additionally, data storage 118 may maintain rules, such as what conference content has been identified as relevant to an absent participant, how to detect relevant content in the conference content, how to summarize such content, and/or other data storage needs. It should be appreciated that data storage 118 may be embodied as a local storage, such as to server 116, and/or an accessible storage, such as an array, server farm, “cloud” and/or other storage device(s) attached directly to server 116 and/or accessible via network 114.

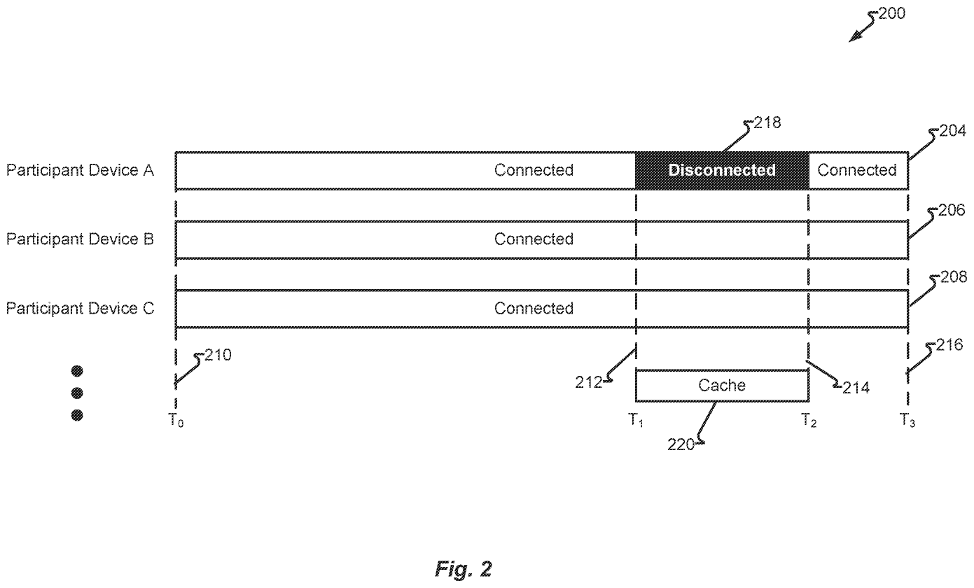

FIG. 2 depicts data structure 200 in accordance with embodiments of the present disclosure. Data structure 200 may be embodied as record maintained in a data storage, such as a memory and/or data storage of server 116, data storage 118, and/or other data storage. In one embodiment, an electronic conference beings at time 210 (T₀) with three or more participants. The connectivity of each participant, (e.g., Participant A, Participant B, Participant C, etc.) via their respective participant communication device (e.g., Participant Device A, Participant Device B, Participant Device C, etc.), being maintained in record 204, 206, and 208, which may be updated in real-time or near-real time as the electronic conference progresses. Each participant is connected to receive conference content via their respective participant communication device (see, FIG. 1).

Server 116 and/or other systems may monitor connectivity of each participant communication device, such as to determine if the connection to server 116 has entirely disconnected or is connected but with such a limited bandwidth that the conference content is unable to be conveyed. For example, record 204, at time 212 (T₁) is determined to be disconnected at portion 218 and, in response, server 116 initiates creation of cache 220.

At a later time, more specifically at time 214 (T₂) portion 218 ends as record 204 indicate that the associated participant communication device has reconnected. As a result caching 220 is terminated and the electronic conference continues until time 216 (T₃) when the electronic conference ends.

In another embodiment, at time 214 a summary of content in cache 220 is generated and presented to the user device (i.e., participant communication device 108) associated with record 204. As a benefit, missed content is presented in an alternative content that better facilitates catching up to the current conference content.

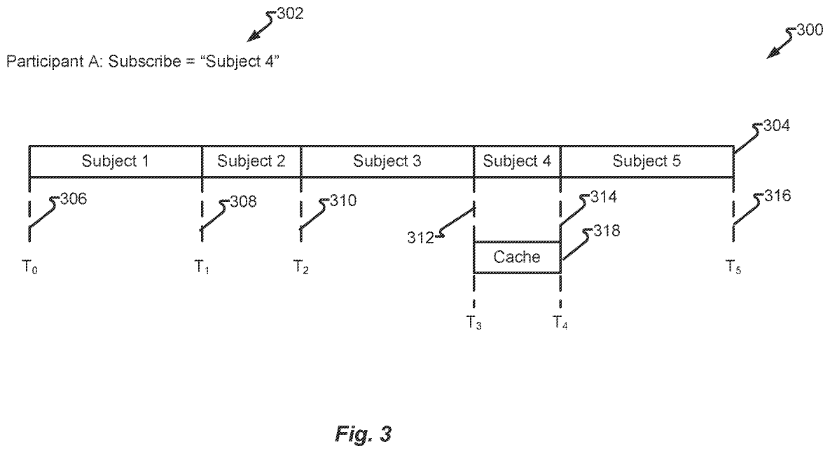

FIG. 3 depicts data structure 300 in accordance with embodiments of the present disclosure. Data structure 300 may be embodied as record maintained in a data storage, such as a memory and/or data storage of server 116, data storage 118, and/or other data storage. In one embodiment, record 302 maintains a previously subscribed subject matter for a particular absent participant. In another embodiment, record 304 charts the progress of the conference content of the electronic conference from the start at time 306 (T₀) and the initiation of a first subject (e.g., “Subject 1”). The conference continues and discusses other topics, such as the discontinuation of the first subject and initiation of the second subject (e.g., “Subject 2”) at time 308 (T₁) and the subsequent discontinuation of the second subject and initiation of a third subject (e.g., “Subject 3”) at time 310 (T₂).

The electronic conference continues and the conference content begins to discuss a fourth subject (e.g., “Subject 4”). Detection of the subject may be performed via speech recognition and optionally speech-to-text transcription for subsequent text analysis to determine an exact or sufficiently matching speech to a current subject to a subscribed subject, such as that maintained in record 302. For example, if a list of service tickets is to be discussed, each having a unique identifier (e.g., “D1111”) then an exact match may be required. In other embodiments, the subscribed subject may be in relation to a particular topic or set of topics. For example, if record 302 maintains a record to a subject, such as “budget for next year,” then time 312 may be identified by the explicit statement (e.g., “let's talk about the budget for next year”) or word or phrase having the same meaning (e.g., “next years budget,” “the upcoming year's budget,” “finances for year 20xx,” etc.”). The determination of what content indicates a subject, when not an exact match, may be provided by an artificially intelligent agent, such as by a processor of server 116 and/or other computing device executing a neural network trained to recognize equivalence in human speech. Additionally or alternatively, recognition may be provided by visual indication, such as a processor of server 116 determining that a visual element of the conference content (e.g., document, image, etc.) comprises an explicit or implicit cue as to the topic being discussed. For example, a participant may share a spreadsheet with a heading “Budget for 20xx” and the audio content absent or supportive (e.g., “now let's talk about this.”). As a result, the processor may determine that the particular subject is being discussed.

Once a subscribed topic is determined to be initiated, such as at time 312, caching begins to create cache 318. Next, termination of the fourth subject is detected and/or initiation of a fifth subject at time 314 (T₄). As can be appreciated, more or fewer topics are then discussed until such time as the electronic conference ends at time 316 (T₅).

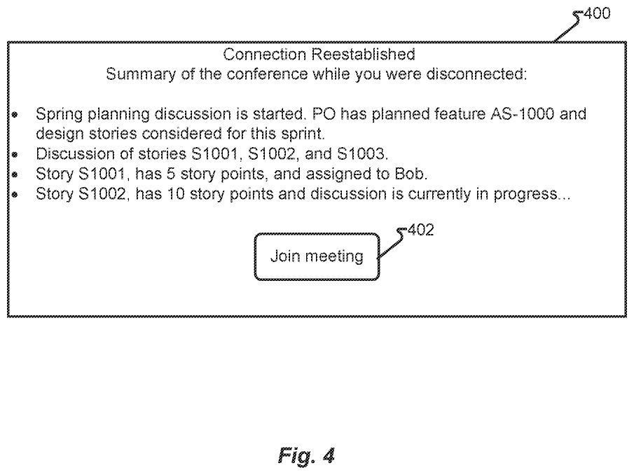

FIG. 4 depicts dialog box 400 in accordance with embodiments of the present disclosure. In one embodiment, a transient participant has joined the electronic conference after the electronic conference has begun, such as late or dropped while the electronic conference was underway, such as at time 212 (see FIG. 2). Subsequently, the transient participant is connected, such as a time 212 (see FIG. 2). During the period of disconnection 218 (see FIG. 2) or at time 212, a processor, such as a processor of server 116 summarizes the missed conference content and presents dialog box 400 comprising textual content summarizing the conference content. An option to join the meeting, such as via an input to button 402, is provided to reconnect the participant communication device to the conference, unless previously connected. Additionally or alternatively dialog box 400 may be provided via a separate channel, such as an email address, text message, or other channel which may be shared or distinct from the electronic conference. While text is one embodiment, additionally or alternatively, the summary provided in dialog box 400 may be provided as audio, such as text-to-speech generated content.

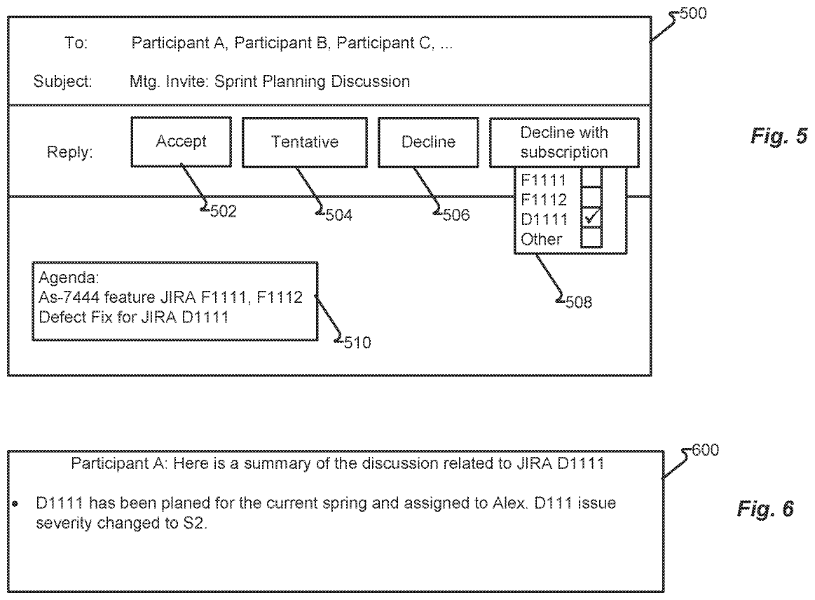

FIG. 5 depicts dialog box 500 in accordance with embodiments of the present disclosure. Dialog box 500 may be embodied as a presentation of an email or other meeting invite to an electronic conference occurring at a future time and addressed to a prospective participant. Dialog box may comprise content, such as agenda 510 to be discussed during the electronic conference. Selection of accept button 502 may send a reply to the conference organizer and/or place indicia of the conference on to a calendar associated with the invitee. Similarly, selection of tentative button 504 may similarly reply and/or place indicia of the conference, but with a “tentative” status. If an invitee will not attend, and has no interest in subscribing, an input to decline button 506 may notify the organizer of the electronic conference and omit placement of indicia on the invitee's calendar.

In another embodiment, an invited participant is an absent participant, and is unable to receive the conference content until after the conference is concluded. Accordingly, decline with subscription button 508 may be selected, which may further present subjects for selection. Once selected the absent participant is subscribed, such as to create record 302 (see FIG. 3). The individual items available for subscription may be manually created, such as by the organizer of the electronic conference and/or automatically, such as via parsing agenda 510.

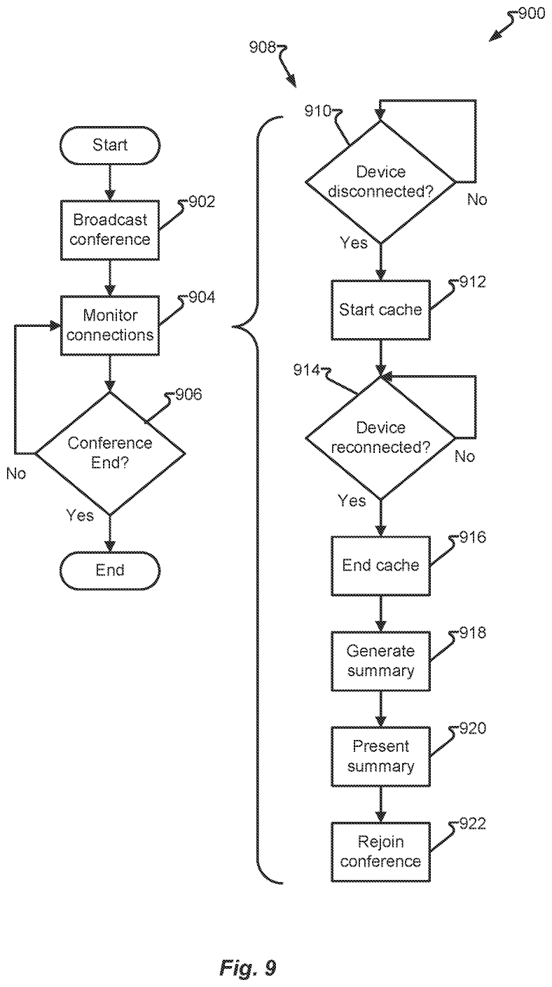

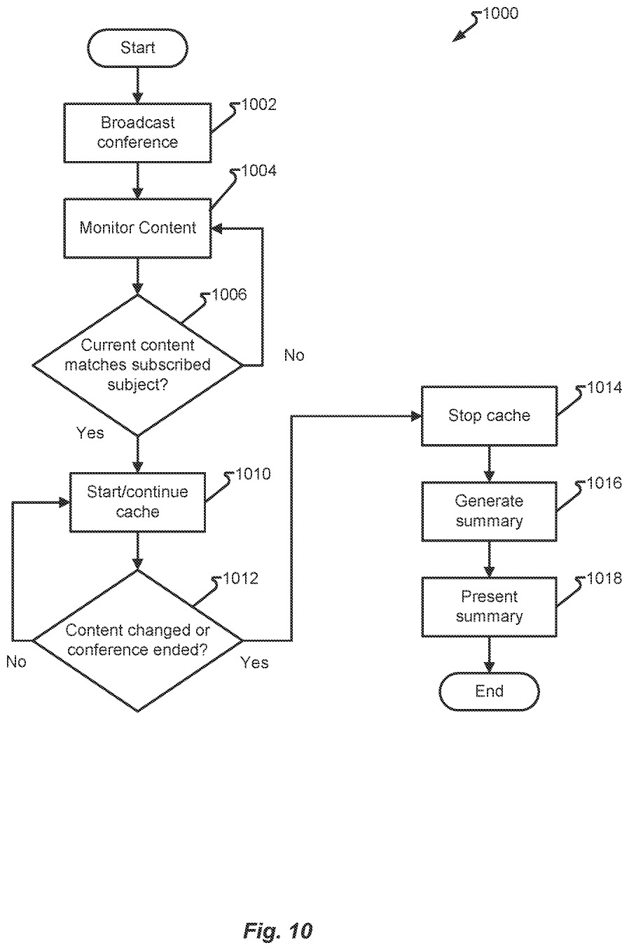

In another embodiment, an invited participant may decline but still receive updates, such as when the invited participant elects to attend another conference that entirely or partially overlaps the conference of a current invitation. As a result, the invited but absent participant may receive some content from the non-attended conference, such as ongoing updates presented in real-time. (See FIGS. 9-10).

FIG. 6 depicts dialog box in 600 accordance with embodiments of the present disclosure. After an electronic conference, such as that declined with subscription (see FIG. 5), dialog box 600 is generated for a portion of the electronic conference that included the subscribed content, such as from cache 318 (see FIG. 3). Dialog box 600 and/or the content therein, is then provided to the subscribing absent participant.

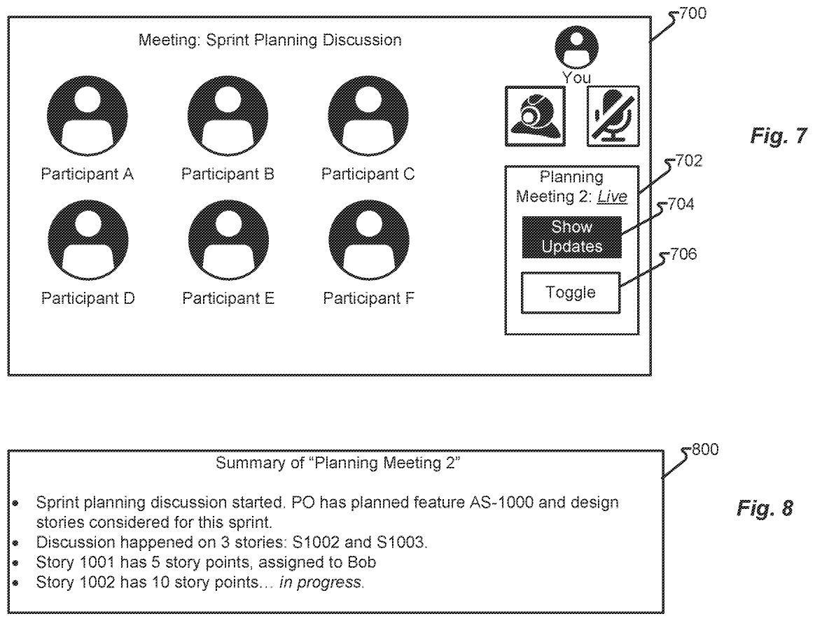

FIG. 7 depicts dialog box 700 in accordance with embodiments of the present disclosure. Dialog box 700 may be the output of a conferencing application, such as to show visual elements (e.g., icons or static or live images of participants), documents, audio (via a speaker associated with participant communication device 108, not shown), and/or other conference content. Additionally or alternatively, dialog box 700 may include states or attributes of the conference, such as whether the device presenting dialog box 700 (e.g., one of participant communication device 108) has a camera providing images and/or a microphone providing sound as a portion of the conference content. The states may be user-determined, such as receive an input to turn on or off a camera or microphone associated with participant communication device 108 and be updated to reflect the status thereof.

In another embodiment, the user of dialog box 700 may have been invited to another conference (“Planning Meeting 2”) but elected to attend the current conference (“Sprint Planning Discussion”). Dialog box 702 may be presented to provide options regarding the other conference. For example, to turn on or off updates from the other conference via selection of “show updates” button 704 or to toggle to the other conference, wherein the other conference is presented in dialog 700 and, additionally or optionally, dialog box 702 comprises options for the original conference (i.e., “Sprint Planning Discussion”). Upon selection of “show updates” button 704, a summary of the other content is generated for presentation on participant communication device 108 (see, FIG. 8).

FIG. 8 depicts dialog box 800 in accordance with embodiments of the present disclosure. In one embodiment, dialog box 800 is provided in real-time (e.g., as fast as processing speed and network communications allow) and summarize the content of a non-attended conference, such as for an absent participant that is current engaged in attending another conference (e.g., “Sprint Planning Discussion” of FIG. 7).

FIG. 9 depicts process 900 in accordance with embodiments of the present disclosure. Process 900 may be embodied as machine-readable instructions that when read by a machine, such as by one or more processors of server 116 and/or other computing device, cause the processor to perform the steps therein. In one embodiment, process 900 begins at an electronic conference is broadcast starting at step 902. Step 904 monitors connections of participant communication devices (e.g., participant communication device 108, participant communication device 110, participant communication device 112, etc.) to server 116 broadcasting the conference content. Test 906 determines if the electronic conference has ended and, if not processing continues back to step 904, otherwise process 900 may end.

It should be appreciated that step 904 may be continually executed while the electronic conference is underway. Step 904 may be further embodied as steps 908 comprising, test 910 determining if a participant communication device has become disconnected from the electronic conference. If test 910 is determined in the negative, test 910 may loop (termination upon end of the conference at test 906 may be implemented). If test 910 is determined in the affirmative, processing continues to step 912 which begins caching the electronic conference. Test 914 determines if the participant communication device has reconnected and, if determined in the negative, loops back to itself. If test 914 is determined in the affirmative, processing continues to step 916 and caching ends.

Step 918 generates a summary of cached content which is presented to the participant communication device in step 920. Optionally step 922 rejoins the participant communication device to the electronic conference.

It should be appreciated that steps 908 may be executed in parallel or series, such as if more than one participant communication device becomes disconnected from the electronic conference. Additionally or alternatively, step 918 may be provided by an AI agent, such as a neural network trained to summarize conference content.

FIG. 10 depicts process 1000 in accordance with embodiments of the present disclosure. Process 1000 may be embodied as machine-readable instructions that when read by a machine, such as by one or more processors of server 116 and/or other computing device, cause the processor to perform the steps therein. In one embodiment, process 1000 begins and electronic conference content is broadcast in step 1002. Step 1004 monitors the conference content and test 1006 determines if the current conference content matches a subscribed subject for at least one absent participant. If test 1006 is determined in the negative, process 1000 loops back to step 1004 and monitoring continues, otherwise processing continues to step 1010.

Step 1010 starts, or continues of already started, caching conference content. Test 1012 determines if the current conference content has changed away from the subscribed conference content and/or a different subject is now included in the conference content. If test 1012 is determined in the negative, processing continues back to step 1010 and caching continues, otherwise processing continues to step 1014.

Step 1014 stops caching the conference content and step 1016 generates a summary of the cached conference content. Step 1018 then presents the conference content to the subscribing participant.

Test 1006 may comprise executing an AI agent, such as neural network trained to determine a match between conference content and a subscribed subject.

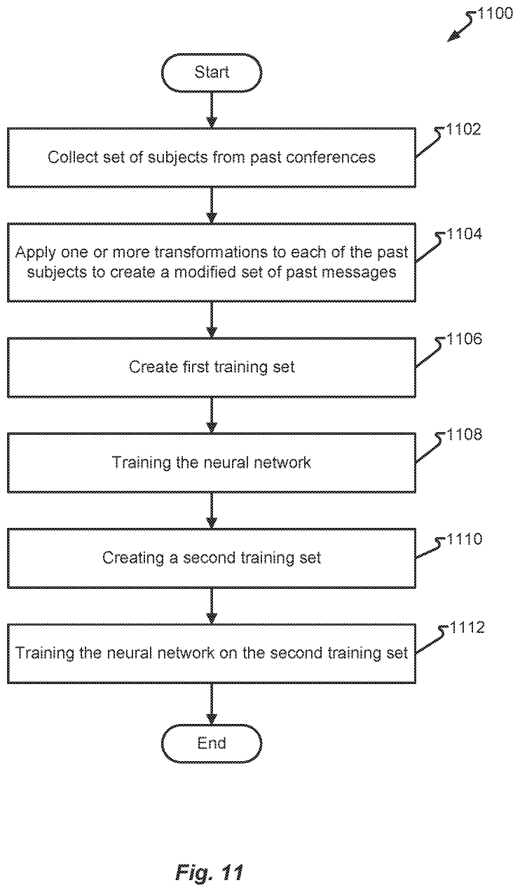

FIG. 11 depicts process 1100 in accordance with embodiments of the present disclosure. Process 1100 may be embodied as machine-readable instructions that when read by a machine, such as by one or more processors of server 116 and/or other computing device, cause the processor to perform the steps therein.

A neural network, as is known in the art and in one embodiment, self-configures layers of logical nodes having an input and an output. If an output is below a self-determined threshold level, the output is omitted (i.e., the inputs are within the inactive response portion of a scale and provide no output), if the self-determined threshold level is above the threshold, an output is provided (i.e., the inputs are within the active response portion of a scale and provide an output), the particular placement of the active and inactive delineation is provided as a training step or steps. Multiple inputs into a node produce a multi-dimensional plane (e.g., hyperplane) to delineate a combination of inputs that are active or inactive.

In one embodiment, a neural network is trained to determine whether a subscribed subject matches content of an electronic conference, or a portion thereof. In another embodiment, a neural network is trained to select words to summarize a portion of conference content.

Process 1100 begins and step 1102 collects a set of subjects from past conferences. Additionally or alternatively, step 1102 may include subjects from other sources (e.g., emails, telephone calls, text messages, etc.). Step 1104 applies one or more transformations to the each of the past subjects to create a modified set of past subjects. The transformations may include one or more of substituting a word with a synonymous word (e.g., “problem” for “ticket,” “issue” for “error,” etc.), substituting a word with a synonymous phrase (e.g., “meeting” for “conference call”, “resolution” for “fix the problem,” etc.), substituting a purpose for a topic associated with the purpose (e.g., “restore bandwidth” for “network degradation”), substituting the topic associated with the purpose of the communication with the purpose (e.g., “network degradation” for “restore bandwidth, etc.), inserting at least one redundant word (e.g., “the”, “a”, “and”, etc.), removing at least one redundant word, removing a first unique topic, and adding a second unique topic (e.g., another unique ticket identifier, an unrelated issue to another issue, etc.).

Next, in step 1106, a first training set comprising the collected set of subjects, the modified set of subjects, and a set of unrelated topics (e.g., historic tasks, historic issues, background information, weather, sports, business news for other companies, personal, etc.) and, in step 1108, training the neural network. Step 1110 then creates a second training set comprising the first training set and the unrelated topics that are incorrectly detected to be one of the set of subjects after the first stage of training and, in step 1112, training the neural network on the second training set.

Upon being trained, the neural network may be provided with content, such as audio content of an electronic conference, and therefrom determine whether a particular subject is being discussed, is no longer being discussed, and/or a different topic that is not the subject is being discussed. While the embodiments described herein are primarily directed to the detection of a subject in an audio portion of an electronic conference, in another embodiment, the neural network may further utilize visual cues, such as presentation slides, documents, etc., provided in a video portion of an electronic conference.

In certain embodiments, summaries may be readily determined, such as when a subject has a defined or enumerated state, such as a priority for a service ticket being changed from medium to high. Additionally or alternatively, the content of an electronic conference may be summarized based on providing the content to a trained neural network that is trained to determine a summarization. For example, in another embodiment, process 1100 begins and step 1102 collects a set of summaries from past conferences. Additionally or alternatively, step 1102 may include summaries from other sources (e.g., emails, telephone calls, text messages, service ticket applications, etc.). Step 1104 applies one or more transformations to each of the past summaries to create a modified set of past subjects. The transformations may include one or more of substituting a word with a synonymous word (e.g., “problem” for “ticket,” “issue,” “fixed” for “closed”, etc.), substituting a word with a synonymous phrase (e.g., “meeting” for “conference call”, “resolution” for “fix the problem,” “give it to Bob” for “reassign to Bob”, etc.), substituting a purpose for a topic associated with the purpose (e.g., “restore bandwidth” for “network degradation”), substituting the topic associated with the purpose of the communication with the purpose (e.g., “network degradation” for “restore bandwidth, etc.), inserting at least one redundant word (e.g., “the”, “a”, “and”, etc.), removing at least one redundant word, removing a first unique topic, and adding a second unique topic (e.g., another unique ticket identifier, an unrelated issue to another issue, etc.).

Next, in step 1106, a first training set comprising the collected set of summaries, the modified set of summaries, and a set of unrelated topics (e.g., historic tasks, historic issues, background information, weather, sports, business news for other companies, personal, etc.) and, in step 1108, training the neural network. Step 1110 then creates a second training set comprising the first training set and the unrelated topics that are incorrectly detected to be one of the set of subjects after the first stage of training and, in step 1112, training the neural network on the second training set.

Upon being trained, the neural network may be provided with content, such as audio content of an electronic conference, and determine a summary for topics, such as service tickets or other events, is being discussed and/or any change in an attribute (e.g., severity, person assigned to resolve, partial resolution, prior resolution that failed or only partially succeeded, etc.). While the embodiments described herein are primarily directed to the detection of summaries in an audio portion of an electronic conference, in another embodiment, the neural network may further utilize visual cues, such as presentation slides, documents, etc., provided in a video portion of an electronic conference.

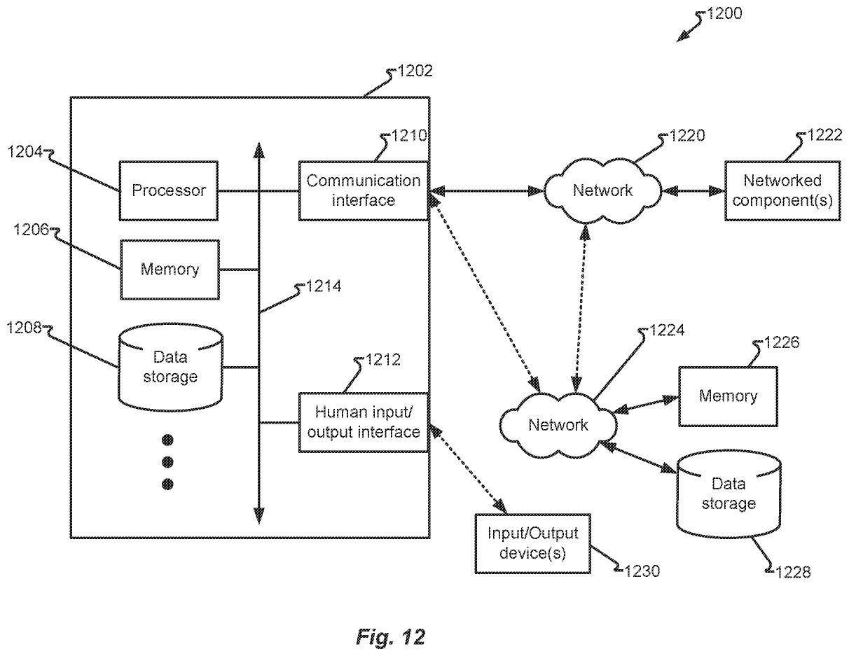

FIG. 12 depicts device 1202 in system 1200 in accordance with embodiments of the present disclosure. In one embodiment, server 116 and/or one of participant communication device (e.g., 108, 110, 112, etc.) providing the services of server 116 and/or data storage 118 may be embodied, in whole or in part, as device 1202 comprising various components and connections to other components and/or systems. The components are variously embodied and may comprise processor 1204. The term “processor,” as used herein, refers exclusively to electronic hardware components comprising electrical circuitry with connections (e.g., pin-outs) to convey encoded electrical signals to and from the electrical circuitry. Processor 1204 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 1214, executes instructions, and outputs data, again such as via bus 1214. In other embodiments, processor 1204 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 1204 is a non-transitory computing device (e.g., electronic machine comprising circuitry and connections to communicate with other components and devices). Processor 1204 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 1204). Processor 1204 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 1204, device 1202 may utilize memory 1206 and/or data storage 1208 for the storage of accessible data, such as instructions, values, etc. Communication interface 1210 facilitates communication with components, such as processor 1204 via bus 1214 with components not accessible via bus 1214. Communication interface 1210 may be embodied as a network port, card, cable, or other configured hardware device. Additionally or alternatively, human input/output interface 1212 connects to one or more interface components to receive and/or present information (e.g., instructions, data, values, etc.) to and/or from a human and/or electronic device. Examples of input/output devices 1230 that may be connected to input/output interface include, but are not limited to, keyboard, mouse, trackball, printers, displays, sensor, switch, relay, speaker, microphone, still and/or video camera, etc. In another embodiment, communication interface 1210 may comprise, or be comprised by, human input/output interface 1212. Communication interface 1210 may be configured to communicate directly with a networked component or utilize one or more networks, such as network 1220 and/or network 1224.

Network 114 may be embodied, in whole or in part, as network 1220. Network 1220 may be a wired network (e.g., Ethernet), wireless (e.g., Wi-Fi, Bluetooth, cellular, etc.) network, or combination thereof and enable device 1202 to communicate with networked component(s) 1222. In other embodiments, network 1220 may be embodied, in whole or in part, as a telephony network (e.g., public switched telephone network (PSTN), private branch exchange (PBX), cellular telephony network, etc.)

Additionally or alternatively, one or more other networks may be utilized. For example, network 1224 may represent a second network, which may facilitate communication with components utilized by device 1202. For example, network 1224 may be an internal network to a business entity or other organization, such as contact center, whereby components are trusted (or at least more so) that networked components 1222, which may be connected to network 1220 comprising a public network (e.g., Internet) that may not be as trusted.

Components attached to network 1224 may include memory 1226, data storage 1228, input/output device(s) 1230, and/or other components that may be accessible to processor 1204. For example, memory 1226 and/or data storage 1228 may supplement or supplant memory 1206 and/or data storage 1208 entirely or for a particular task or purpose. For example, memory 1226 and/or data storage 1228 may be an external data repository (e.g., server farm, array, “cloud,” etc.) and allow device 1202, and/or other devices, to access data thereon. Similarly, input/output device(s) 1230 may be accessed by processor 1204 via human input/output interface 1212 and/or via communication interface 1210 either directly, via network 1224, via network 1220 alone (not shown), or via networks 1224 and 1220. Each of memory 1206, data storage 1208, memory 1226, data storage 1228 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 1230 may be a router, switch, port, or other communication component such that a particular output of processor 1204 enables (or disables) input/output device 1230, which may be associated with network 1220 and/or network 1224, to allow (or disallow) communications between two or more nodes on network 1220 and/or network 1224. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM1926EJS™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system for providing summarized content of an electronic conference, comprising:
a network interface to a communications network;
a conference server presenting conference content to a plurality of participant devices and receive the conference content from at least one of the participant devices, wherein the conference content comprises an audio portion further comprising encoded speech from speech received from at least one of the participant devices;
a processor, comprising one or more microprocessors, having machine-readable instructions maintained in a non-transitory memory that, when read by the processor, cause the processor to perform:
determining, at a first time, that an intermittent participant device, of the plurality of participant devices, is not receiving the conference content and, in response, initiate caching of the conference content;
generating a summary of the conference content starting at the first time; and
determining that the intermittent participant device is receiving the conference content, presenting the summary of the conference content to the intermittent participant device.

2. The system of claim 1, wherein the intermittent participant device is selected from the plurality of participant devices scheduled to attend the electronic conference but absent therefrom.

3. The system of claim 1, wherein the instructions cause the processor to further perform determining, at a second time after the first time, that the intermittent participant device, is receiving the conference content and terminating the caching of the conference content.

4. The system of claim 1, wherein the intermittent participant device is selected from the plurality of participant devices scheduled to not attend the electronic conference but having subscribed to a first subject of the electronic conference and, wherein the first time comprises inclusion of the subject in the electronic conference.

5. The system of claim 1, wherein determining that the intermittent participant device is receiving the conference content, further consisting of the summary of the conference content and providing the summary of the conference content to the intermittent participant device in real-time.

6. The system of claim 5, wherein the intermittent participant receives conference content of a different conference while receiving the summary of the conference content.

7. The system of claim 4, wherein the instructions cause the processor to further perform determining, at a second time after the first time, that the content of the electronic conference comprises at least one of a second subject of subject that is different from the first subject or terminated discussion of the first subject and, in response thereto, terminating caching of the conference content.

8. The system of claim 1, wherein generating the summary comprises providing the cached conference content to a neural network trained to detect the subject in the electronic conference.

9. The system of claim 8, wherein the instructions further cause the processor to perform
collecting a set of subjects discussed in a speech portion of the conference from a database;
applying one or more transformations to each subject of the set of subjects including one or more of substituting a word with a synonymous word, substituting a word with a synonymous phrase, substituting a purpose for a topic associated with the purpose, substituting the topic associated with the purpose of the communication with the purpose, inserting at least one redundant word, removing at least one redundant word, removing a first unique topic, and adding a second unique topic to create a modified set of subjects discussed in the audio portion;
creating a first training set comprising the collected set of subjects discussed in the audio portion of the conference, the modified set of subjects discussed in the audio portion, and a set of unrelated topics;
training the neural network in a first stage using the first training set;
creating a second training set for a second stage of training comprising the first training set and unrelated topics that are incorrectly detected as one of the set of subjects after the first stage of training; and
training the neural network in the second stage using the second training set.

10. The system of claim 1, wherein the subject comprises at least one of a number of subjects identified prior to the occurrence of the electronic conference.

11. The system of claim 1, wherein the subject comprises a specified subject provided by a user of at least one of the participant devices.

12. The system of claim 1, wherein the subject is one of a plurality of subjects and less than the entirety of the electronic conference.

13. The system of claim 1, wherein generation of the summary further comprises generating the summary to include an attribute change of the subject.

14. The system of claim 1, wherein generation of the attribute change comprises a status change of the subject.

15. The system of claim 1, wherein presenting the summary of the conference content comprises providing the summary to a user corresponding to the intermittent participant device via a communication channel distinct from the electronic conference.

16. The system of claim 1, wherein presenting the summary of the conference content comprises presenting at summary as at least one of a text or audio.

17. A system for providing summarized content of an electronic conference, comprising:
a network interface to a communications network;
a conference server presenting conference content to a plurality of participant devices and receive the conference content from at least one of the participant devices, wherein the conference content comprises an audio portion further comprising encoded speech from speech received from at least one of the participant devices;
a processor, comprising one or more microprocessors, having machine-readable instructions maintained in a non-transitory memory that, when read by the processor, cause the processor to perform:
determining, that a subscriber has registered an interest in a subject and that the conference content comprises a discussion of the subject and, in response, initiate caching of the conference content;
generating a summary of the conference content; and
presenting the summary to a device associated with the subscriber.

18. The system of claim 17, wherein the generating and presenting of the summary is provided in real-time to a device associated with the subscriber.

19. The system of claim 18, wherein the device associated with the subscriber receives conference content of a second conference.

20. The system of claim 17, wherein the instructions further cause the processor to perform:
prior to the occurrence of the electronic conference, sending an invitation to the subscriber and, in response, receiving the subject.

21. The system of claim 17, wherein generating the summary comprises providing the cached conference content to a neural network trained to detect the subject in the electronic conference.

22. The system of claim 20, wherein the instructions further cause the processor to perform collecting a set of subjects discussed in a speech portion of the conference from a database;
applying one or more transformations to each subject of the set of subjects including one or more of substituting a word with a synonymous word, substituting a word with a synonymous phrase, substituting a purpose for a subject associated with the purpose, substituting the subject associated with the purpose of the communication with the purpose, inserting at least one redundant word, removing at least one redundant word, removing a first unique subject, and adding a second unique subject to create a modified set of subjects discussed in the audio portion;
creating a first training set comprising the collected set of subjects discussed in the audio portion of the conference, the modified set of subjects discussed in the audio portion, and a set of unrelated subject;
training the neural network in a first stage using the first training set;
creating a second training set for a second stage of training comprising the first training set and unrelated subjects that incorrectly detected as one of the set of subjects after the first stage of training; and
training the neural network in the second stage using the second training set.

23. A method of providing summarized content of an electronic conference, comprising:
presenting, by at least one microprocessor having a network interface to a communications network, conference content to a plurality of participant devices and receiving the conference content from at least one of the participant devices, wherein the conference content comprises an audio portion further comprising encoded speech from speech received from at least one of the participant devices;
determining, at a first time, that an intermittent participant device, of the plurality of participant devices, is not receiving the conference content and, in response, initiate caching of the conference content;
generating a summary of the conference content starting at the first time; and
determining that the intermittent participant device is receiving the conference content, presenting the summary of the conference content to the intermittent participant device.

24. The method of claim 23, wherein:
the intermittent participant device is not presented with the electronic conference as it occurs; and
determining, at the first time, that the intermittent participant device is not receiving any portion of the conference content, initiate caching of the conference content, upon further determining that the conference content comprises a subject previously subscribed to by a user associated with the intermittent participant device.
